(19) United States
(12) Patent Application Publication
(10) Pub. No.: US 2013/0304735 A1
(43) Pub. Date: Nov. 14, 2013

(54) RECORDS MANAGEMENT SYSTEM

(71) Applicants: Samuel A. Fineberg, Palo Alto, CA (US); Rory James Kleeman, Narooma (AU); Urs Raas, Newbury (GB)

(72) Inventors: Samuel A. Fineberg, Palo Alto, CA (US); Rory James Kleeman, Narooma (AU); Urs Raas, Newbury (GB)

(21) Appl. No.: 13/980,350

(22) PCT Filed: Mar. 3, 2011
(86) PCT No.: PCT/US2011/027072

§ 371 Date: Jul. 18, 2013

(51) Int. Cl. G06F 17/30

(52) U.S. Cl. CPC G06F 17/30386
USPC 707/736

(57) ABSTRACT

A records management system may include a policy management module receiving a policy related to retention, disposition or hold of information storable on an external storage system. A computerized management module may associate a unique record identifier with a collection record including metadata for the information. The unique record identifier may enable management of the information by the computerized management module when the unique record identifier and the information are stored on the external storage system.

### BACKGROUND

Storage and management of large volumes of information can be expensive, and can require consideration of issues such as scalability, performance, database footprint, etc. An example of such information can include audit related information. For private enterprise and particularly large organizations, information stored for such government audit compliance purposes but otherwise not needed for day to day business operations can become voluminous. With ever-increasing government regulations and compliance requirements, the volume of such information can often grow in the range of petabytes.

Examples of systems that are used to share and manage such information include traditional record management systems on which all of the information is stored, or archive systems that enable storage of information without a central record management system. These systems can provide the links between different pieces of information to create complete records of individual business transactions that can be accessed and contributed to by authorized users. These systems can also be subjected to corporate records management policies managed by records management specialists. While such systems can be useful for information that is used in the everyday business, for large volumes of information stored for compliance or other purposes where day to day accessibility is not needed, the foregoing systems can be expensive, and can have limited scalability and performance. The foregoing systems can also have large database footprints.

### BRIEF DESCRIPTION OF DRAWINGS

The embodiments are described in detail in the following description with reference to the following figures.

FIG. 1 illustrates a central records management system, according to an embodiment;

FIG. 2 illustrates fixed collection record creation, according to an embodiment;

FIG. 3 illustrates dynamic collection record creation, according to an embodiment;

FIG. 4 illustrates fixed collection record destruction, according to an embodiment;

FIG. 5 illustrates dynamic collection record destruction, according to an embodiment;

FIG. 6 illustrates dynamic collection record holds, according to an embodiment;

FIG. 7 illustrates dynamic collection record hold release, according to an embodiment;

FIG. 8 illustrates a method for information capture, according to an embodiment;

FIG. 9 illustrates a method for policy execution, according to an embodiment; and

FIG. 10 illustrates a computer system that may be used for the method and system, according to an embodiment.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It will be apparent that the embodiments may be practiced without limitation to all the specific details. Also, the embodiments may be used together in various combinations.

### 1. Overview

According to an embodiment, a central records management system (RMS) may implement retention management over a broad range of content repositories. The retention management may include retention, disposition and hold of information stored in the content repositories. Disposition of information may include destruction of information, or otherwise relocation of information. The term information may be broadly used interchangeably with the terms data or items. Examples of data or items may include contracts, invoices, customer correspondence, or business documents. The content repositories may be external to the central RMS. Examples of repositories may include archive systems, file servers, or other content management systems. The central RMS may be the records authority where retention policies are defined and managed for such repositories. The central RMS may provide a mechanism for archival systems to delegate the management of collections of stored information to the central RMS. In an example, the archival systems may be federated archival systems. In an example, the stored information may be compliance information. The central RMS may thus provide a central point of policy management and application. In an example, the central RMS also allows organizations to include compliance-type information in records relationships. This provides additional business context, for example, in audit and e-discovery situations.

The central RMS enables storage of a single record per collection, thus eliminating the need for centralized metadata for every single item in the collection that is being managed. The central RMS may link metadata in its central repository to multiple metadata entries in external content repositories, to thus reduce the number of metadata entries in its central repository. This provides a relatively smaller record management database footprint. This also provides improved scalability and performance, while supporting the needed retention and hold management. In an example, the central RMS enables accessibility of stored information by querying of an information storage system (StS). In an example, the StS may be a federated StS. The StS prevents deletion or change by entities other than the central RMS, thus providing centralized retention management by the central RMS.

### 2. System

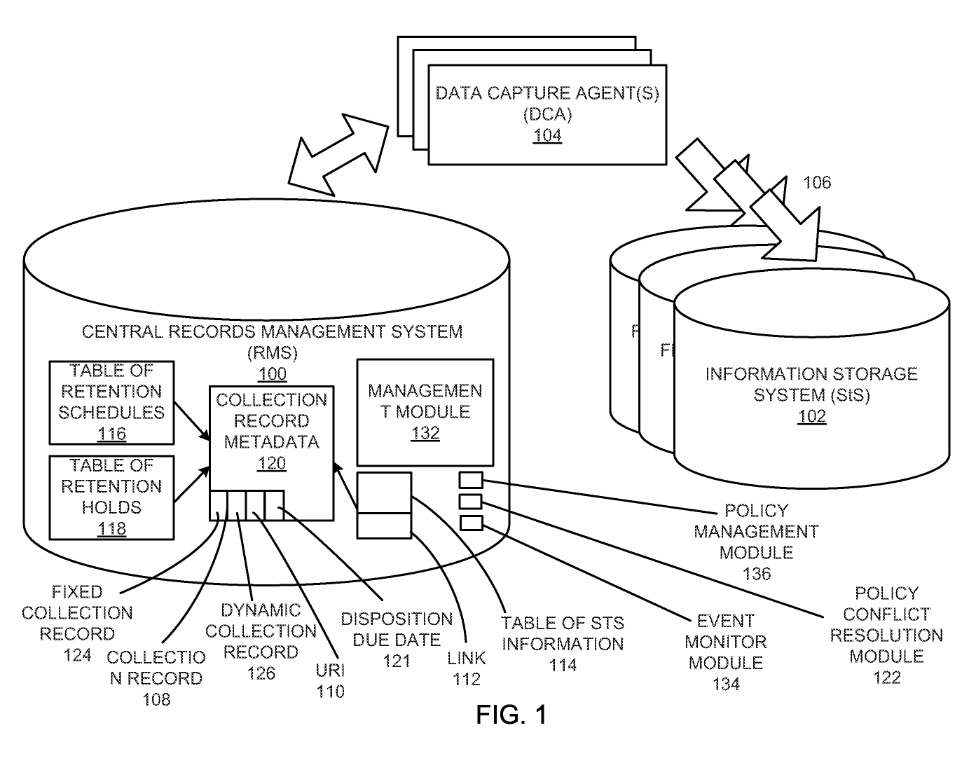

FIG. 1 illustrates a central RMS 100, according to an embodiment. As shown in FIG. 1, the central RMS 100 may be interfaced with a variety of StSs 102 and their data capture agents (DCAs) 104. In an example, the StS 102 may be a federated StS, or another type of storage system. Federated StSs generally refer to systems that have the ability to establish, execute, and enforce a common records policy across distributed, heterogeneous records repositories, using a set of standards that provide interoperability for functions such as retention and disposition, and other functions throughout the life cycle of a record. Examples of a DCA may include a program running on a computer for deciding if something is a record, an automated agent that pulls information from a file system or out of an e-mail box, something being retrieved from a scanner, or a manual process for retrieving information. The management of information by the central RMS 100 may broadly include capture of information, protection of information from premature destruction (e.g. retention), and destruction of information (e.g. disposition).

Capture of information is now described with reference to FIGS. 1-3.

Referring to FIG. 1, in order to capture a centrally managed collection of information in the StS 102, the DCA 104 may identify information 106 to be stored. The DCA 104 may inquire with the central RMS 100 by making a “create collection record” call, whereby the central RMS 100 creates a collection record 108 and returns a unique record identifier (URI) 110 to the DCA 104. A management module 132 in the central RMS 100 may associate the URI 110 with the collection record 108, and perform the various other control and management functions described herein. A module and other components of the system may be implemented in hardware, machine readable instructions, or a combination thereof. The URI 110 and the collection record 108 may be associated with a capture policy. The capture policy may provide guidance for capture and retention of the information 106. Policies related to capture, retention, disposition and hold of information may be received and managed by a policy management module 136. The DCA 104 may store the information 106 in the target StS 102 and tag the information 106 with the URI 110.

Alternatively, the DCA 104 may inquire with the central RMS 100 to select a capture policy. The DCA 104 may then create a collection under the capture policy and inform the central RMS 100 of the collected information 106. The central RMS 100 may then create a collection record 108, assign the capture policy to the collection record 108, and associate a URI 110 with the collection record 108 and the capture policy. Alternatively, the collection record 108 may already exist before assignation of the capture policy.

Alternatively, the DCA 104 may create a collection under the capture policy and inform the central RMS 100 of the collected information 106. The central RMS 100 may then create a collection record 108, and associate a URI 110 with the collection record 108. A management policy may be subsequently created and assigned to the URI 110 and the collection record 108.

The collection record 108 in the central RMS 100 may be a single metadata representation of all the information 106 that is captured and stored in any StS and tagged with its URI. An example of the information 106 may include invoices, with the collection record 108 representing all invoices captured in a given week, and the URI 110 representing the collection record 108 that includes the captured invoices. The collection record 108 may relate to an instance of a rule belonging to the capture policy. For example, for a rule requiring retention of invoices for 7 years for a policy related to retention of documents, instances of the rule may respectively include invoices captured each month (e.g. January, February, March etc.). The instances of the rule subsequently permit retention, disposition and hold management aspects of the information 106 based on the specific dates and other information in the instances that permit calculation of due dates for retention, disposition and hold, which may be persisted and indexed as part of collection record metadata 120. As part of the record, the central RMS 100 may store a link 112 to the StS where the records are kept. Information about each StS may be stored as a separate item in the central RMS 100, for example in a table of StS information 114. The information may pertain to the interface that is to be used to execute deletion of RMS managed data stored by each StS.

The collection record 108 may include a fixed collection record 124 or a dynamic collection record 126.

The fixed collection record 124 may include a set of items with the same URI 110 that are all to be managed as a single collection. An example of a fixed collection record may include a collection of invoices captured during a week of a given year, for example, Feb. 18, 2011. Thus from the perspective of the central RMS 100, all invoices captured for the week of Feb. 18, 2011 may be managed as a single collection.

The dynamic collection record 126 may include a set of items with the same URI 110 that are to be individually managed based on particular item-level selection criteria. Thus the dynamic collection record 126 may include a URI and an associated item-level selection criteria specific to the items in the collection. An example of a dynamic collection record may include capture of invoices over a given period, for example, 7 years. Thus for every new invoice created, that invoice may be stored in an external StS 102 with a pre-assigned URI 110 referring back to the original collection record 126. In this manner, when invoices in the collection record 126 exceed the 7 year window, those invoices may be destroyed, with new invoices being added to the StS 102 upon creation. If no new items are added to such a dynamic collection record, the items may be systematically destroyed as they reach a maturity date (e.g. 7 years in this example), until the collection is empty.

Based on the foregoing, with regard to capture of information, the DCA 104 may identify information to be captured, and create the collection record 108 inside the central RMS 100. Alternatively, the collection record 108 may already exist. The collection record 108 may represent a large number of records or information being captured. The DCA 104 may also notify the central RMS 100 whether a collection is fixed or dynamic, and initiate storage of items in the StS 102 with the URI 110 associated with the collection record 108 and provided by the central RMS 100. The central RMS 100 may store the collection record 108 as fixed or dynamic, and link the collection record 108 to the information for the particular StS 102. The central RMS 100 may also assign a retention schedule to the collection record 108, and pass the URI 110 to the DCA 104. The StS 102 may receive items and the URI 110 (received from the central RMS 100) from the DCA 104, and store items tagged with the central RMS URI 110. The URI 110 may thus link a collection of items stored in the StS 102 back to the collection record 108 in the central RMS 100. The central RMS 100 thus enables storage of a single collection record 108 per collection, thus eliminating the need for metadata for every single item in the collection that is being managed.

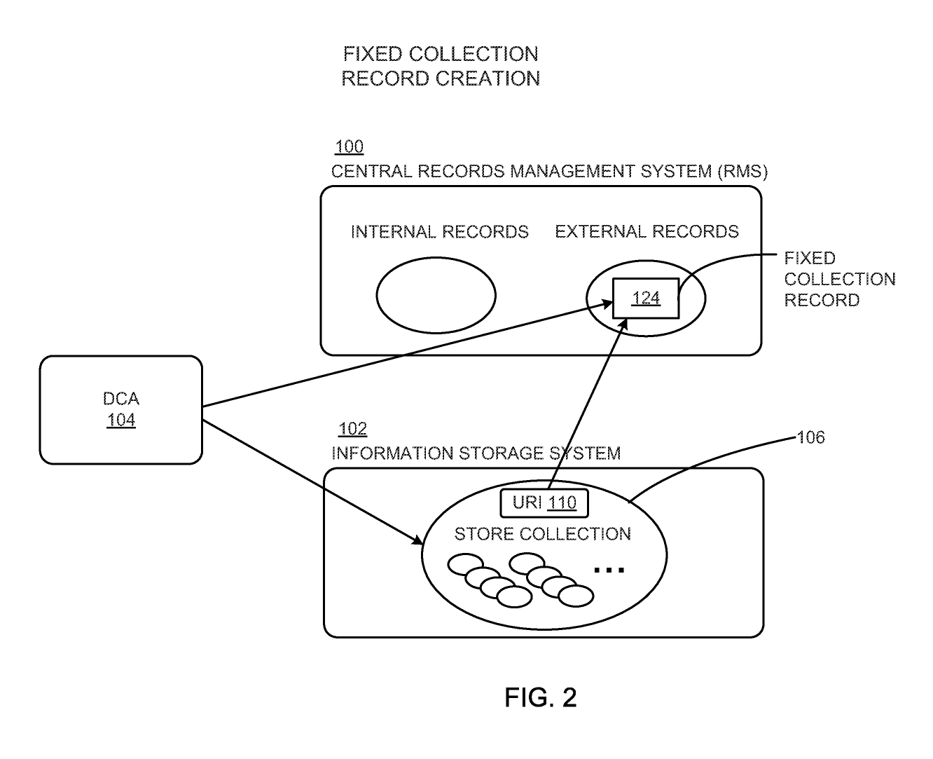

Referring to FIG. 2, in an alternate embodiment, the fixed collection record 124 may be created by the DCA 104 first initiating capture and storage of items in the StS 102. In FIG. 2, the internal records refer to items stored in the central RMS, and external records refer to items in an external StS 102. The DCA 104 may create the URI 110 and store the URI 110 in the metadata for each item stored in the StS 102. Retention management of the items stored in the StS 102 may be assigned to the central RMS 100. The fixed collection record 124 may then be created and stored in the central RMS 100. The URI 110 may be stored in the fixed collection record 124. In this manner, the URI 110 points to the fixed collection record 124 in the central RMS 100, and the fixed collection record 124 is assigned to the collection of all items stored in the StS 102.

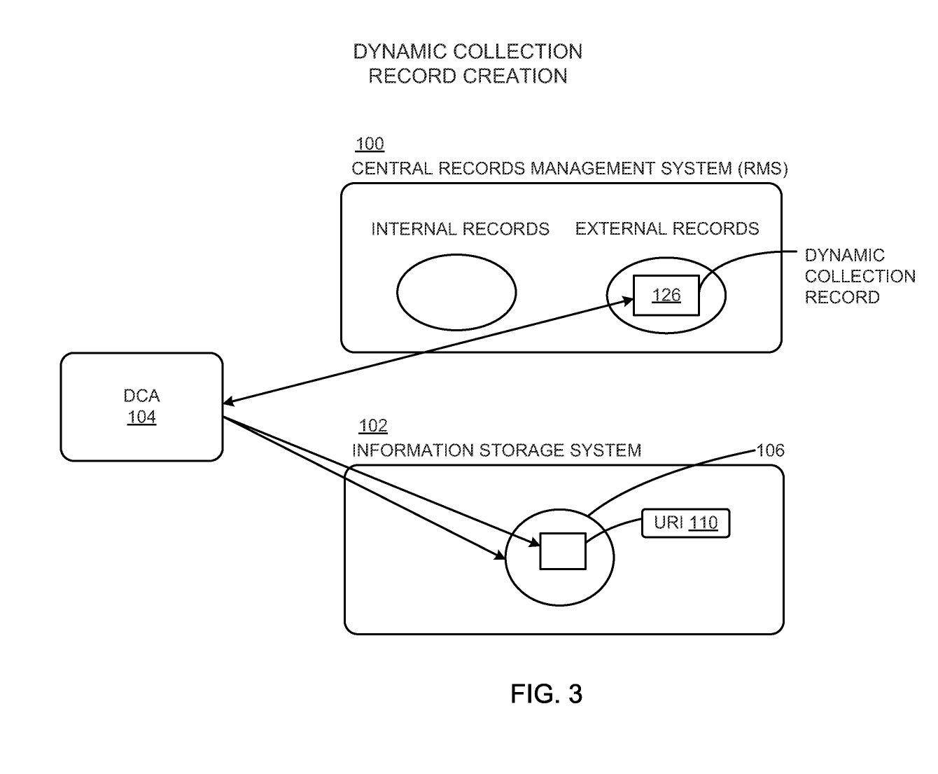

Referring to FIG. 3, the dynamic collection record 126 may be created by the DCA 104 first initiating capture and storage of an item in the StS 102. The DCA 104 may then create or ascertain the URI 110 for the dynamic collection record 126 associated with the record classification. The URI 110 may be stored in the metadata for each item stored in the StS 102. Retention management of the items stored in the StS 102 may be assigned to the central RMS 100.

Protection of information is now described with reference to FIG. 1.

In order to protect information from premature destruction, any information that is stored in a StS and is marked with the URI 110 from the central RMS 100 or created as described above may be exempt from standard StS deletion facilities by either a customized protective logic or by application of standard access controls (e.g. by allocating control to a user account with the central RMS 100). In either case, the authority for destruction is thus assigned to the central RMS 100. As described earlier, the management module 132 in the central RMS 100 may perform the various control and management functions described herein.

The central RMS 100 may apply its standard retention management functionality to the collection record 108 it stores. This may include the calculation of destruction due dates based on the particular retention schedule applied, as well as the suspension of destruction when the collection record 108 is assigned a hold. The destruction dates and/or suspension may be recalculated whenever a change to the assigned retention schedule or assigned hold occurs.

Thus based on the foregoing, with regard to protection of information from premature destruction, the DCA 104 may defer issues related to protection from destruction to the central RMS 100 and the StS 102. Referring to FIG. 1, the central RMS 100 may calculate a destruction due date based on retention schedule and hold information, for example, from a table of retention schedules 116 and a table of retention holds 118. The information from the table of StS information 114, and tables 116 and 118 being collectively stored in the collection record metadata 120. The central RMS 100 may recalculate due dates when the retention schedules and/or retention holds respectively specified in tables 116 and 118 are changed. The central RMS 100 may monitor due dates for the non-destroyed collection records 108. The StS 102 may protect items tagged with the URI 110 received from the central RMS 100 from deletion by any entity other than the central RMS 100.

Destruction of information is now described with reference to FIGS. 1, 4 and 5.

In order to implement destruction of information generally, an event monitor module 134 may check at regular intervals for any destruction due dates that have passed and where the collection record 108 is not already marked, for example, as destroyed. For any collection records 108 that are identified as being due for destruction, the central RMS 100 may look up information for the StS 102 and issue the relevant deletion command.

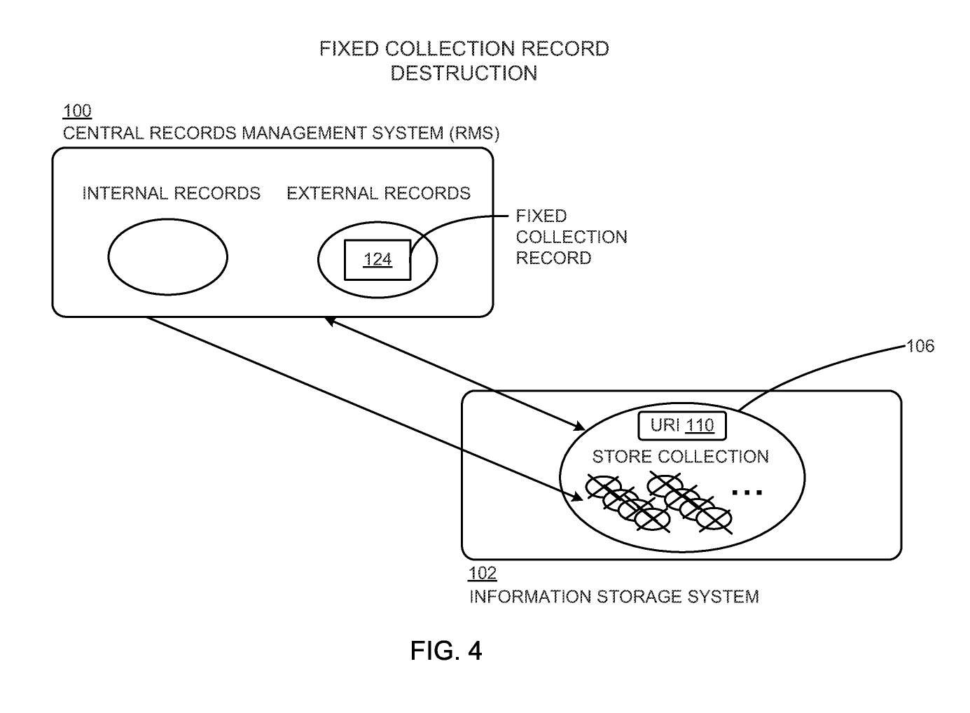

Referring to FIG. 4, for destruction of fixed collections; the central RMS 100 may send or execute a delete command for all stored items with the URI 110 of the fixed collection record 124. Once the fixed collection record 124 expires (e.g. the retention period has run out), it is no longer subject to hold and thus subject to destruction. Thus upon expiration of the fixed collection record 124, the central RMS 100 may query the StS 102 for records containing the URI 110. Thereafter, the central RMS 100 initiates deletion of all stored items with the URI 110 of the fixed collection record 124. Once the central RMS 100 receives a deletion success notification, it may mark the fixed collection record 124 as destroyed and retain the fixed collection record 124 as evidence of the destruction.

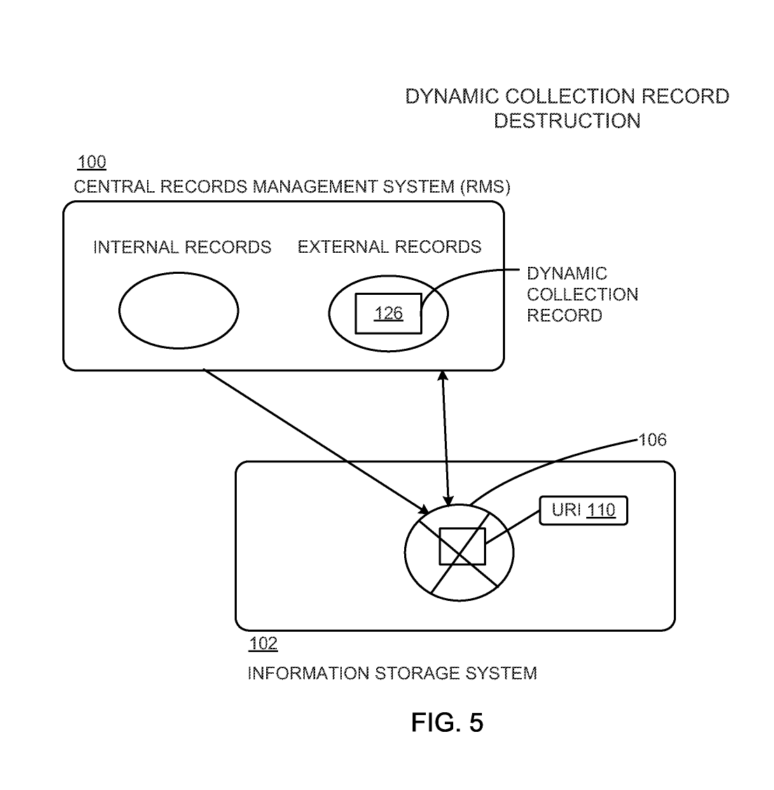

Referring to FIG. 5, for destruction of dynamic collections, the central RMS 100 may send or execute a delete command for all stored items with the URI 110 of the dynamic collection record 126, and further send or execute an item specific selection criteria. The central RMS 100 may query the StS 102 for items that contain an associated URI 110, are older than a specified retention lifetime, and are not associated with any hold URI 128 (described below). The central RMS 100 may then delete any items that match the foregoing query. Upon receipt of a deletion success notification, the central RMS 100 may query the StS 102 for any remaining items in the collection. If there are any remaining items in the collection, the central RMS 100 will not mark the collection record 126 as destroyed. This means that the collection record 126 may be submitted to the destruction process again the next time the foregoing event monitor runs. Once there are no remaining items, the collection record 126 may be marked as destroyed and excluded from the process in the same way as a fixed collection.

Based on the foregoing, with regard to destruction of information, the DCA 104 may defer issues related to destruction of information to the central RMS 100 and the StS 102. The central RMS 100 may issue a fixed or dynamic delete command to the StS 102 for each non-destroyed collection record with a destruction due date in the past. The central RMS 100 may also mark the collection record 108 as destroyed when there are no more items in the StS 102 with the associated URI 110. The StS 102 may execute the deletion based on the command/query passed to it by the central RMS 100, and report back on the number or items with a particular URI 110.

Hold and release of information is now described with reference to FIGS. 1, 6 and 7.

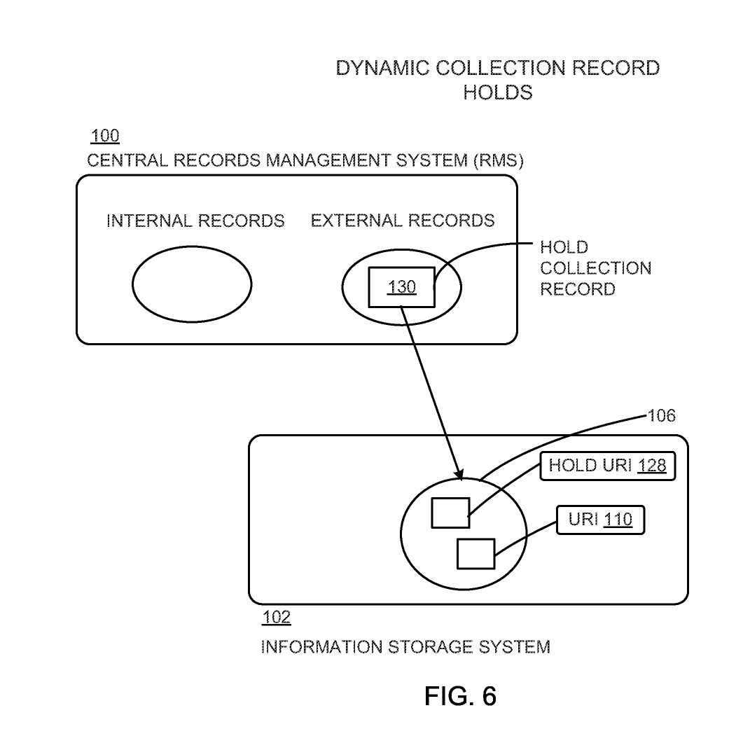

Referring to FIG. 6, in an alternate embodiment, in order to perform a hold for an item belonging to a dynamic collection record 126, since certain items from a dynamic collection record may need to be placed on hold, a hold URI 128 referencing a hold collection record 130 may be stored in the metadata of the affected items to thus identify the items that are to be placed on hold. A hold may include retention and maintenance of information 106 superseding any pre-existing destruction schedule, for example, for compliance purposes such as legal discovery. The hold URI 128 may also reference more than one collection record. For example, if a hold is to be applied to individual items across multiple collections, a new hold collection record 130 may be created and stamped with the hold URI 128. The items that are thus placed on the hold function similar to items of a fixed collection record. As shown in FIG. 6, the hold URI 128 may be used to identify the items placed on hold and the URI 110 may be used to identify the remaining items of the dynamic collection record 126. The items remaining in the dynamic collection record 126 may be subject to retention and destruction as described above.

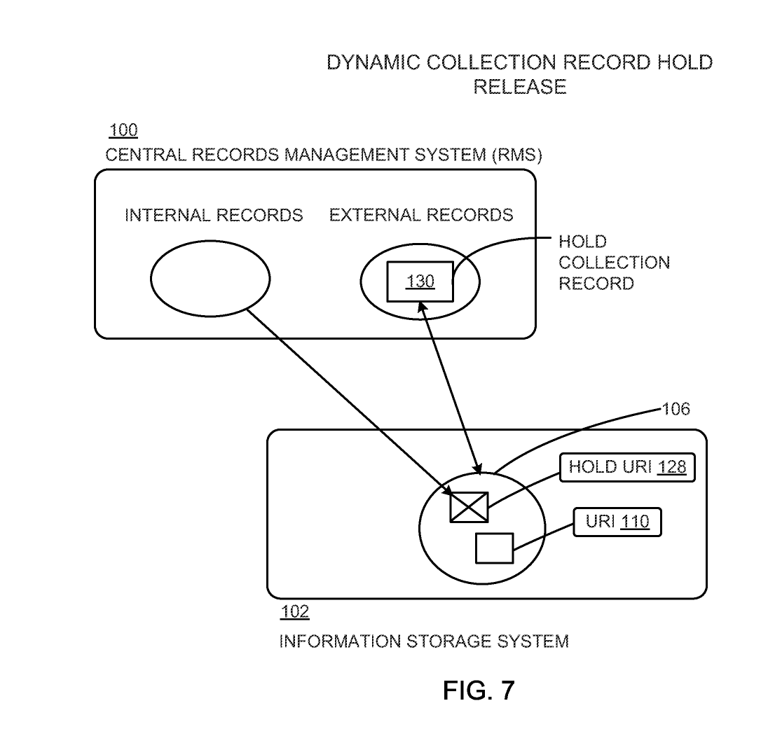

Referring to FIG. 7, in order to release a hold, the central RMS 100 may query the StS 102 to determine which items have hold URI 128. The central RMS 100 may then delete the hold collection record 130, and remove the hold URI 128 from any affected items.

In order to perform a hold for an item belonging to a fixed collection record 124, the entire collection record 124 may be held or released as needed by a hold command from the central RMS 100. Such a hold command may supersede any destruction command from central RMS 100 until release of the hold.

Access of information, policy implementation and conflict resolution is now described.

In order to access information in a given StS 102, a user may access the central RMS 100 to determine which StS 102 has the information from the collection record metadata 120 in the central RMS 100. As described above, the collection record metadata 120 in the central RMS 100 may include information related to each StS 102 managed by the central RMS 100 in the table of StS information 114, and further include the tables of retention schedules 116 and retention holds 118. The collection record metadata 120 may also include information related to the URI 110 of each collection record 108. Based on this information in the central RMS 100, the central RMS 100 can determine which StS 102 has the requested information and forward the information or direct the user to the information. For a federated StS, the central RMS 100 can determine which StS 102 has the requested information and forward the information or direct the user to the federated information. The user may then query and obtain the requested information from the appropriate StS 102, or obtain the information via the central RMS 100.

In order to implement a policy, the central RMS 100 may use information stored in collection record metadata 120 to determine which URI 110 refers to a given collection record 108. As described above, policies related to capture, retention, disposition and hold of information may be managed by the policy management module 136. Thus based on a policy, the central RMS 100 may determine which StS 102 includes relevant information based on the collection record 108, the associated URI 110 and information related to the table of StS information 114. Upon creation of a policy, a URI 110 and/or collection record 108 may be associated with the policy for subsequent determination of where information in the collection record is stored. A policy may also be identified as fixed or dynamic to thus generate a fixed or dynamic collection. For a fixed policy, a URI 110 may be associated with the fixed collection record 124. For a dynamic policy, a URI 110 and a particular item-level selection criteria may be associated with the dynamic collection record 126.

Policy conflicts may be resolved in the central RMS 100 via a policy conflict resolution module 122. The module 122 may review conflicting policies and make a decision to implement a conservative policy. For example, if a first policy requires retention of all invoices, and a second policy requires retention of invoices less than 5 years old, the former policy for retaining all invoices may be chosen.

### 3. Method

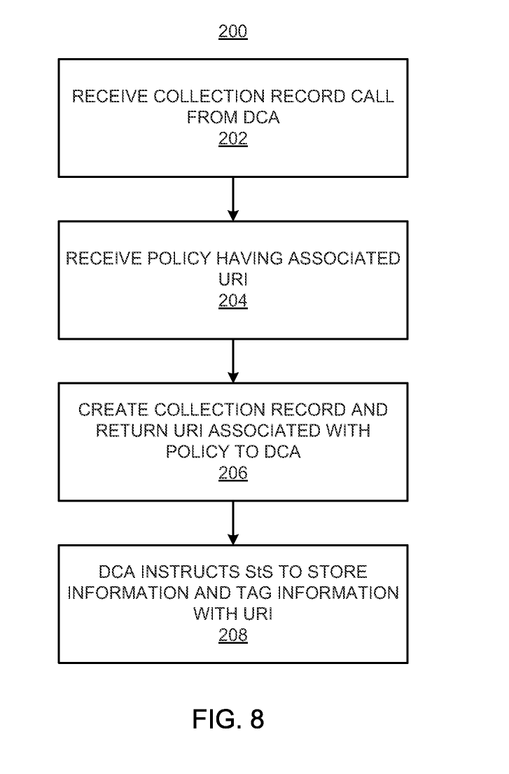

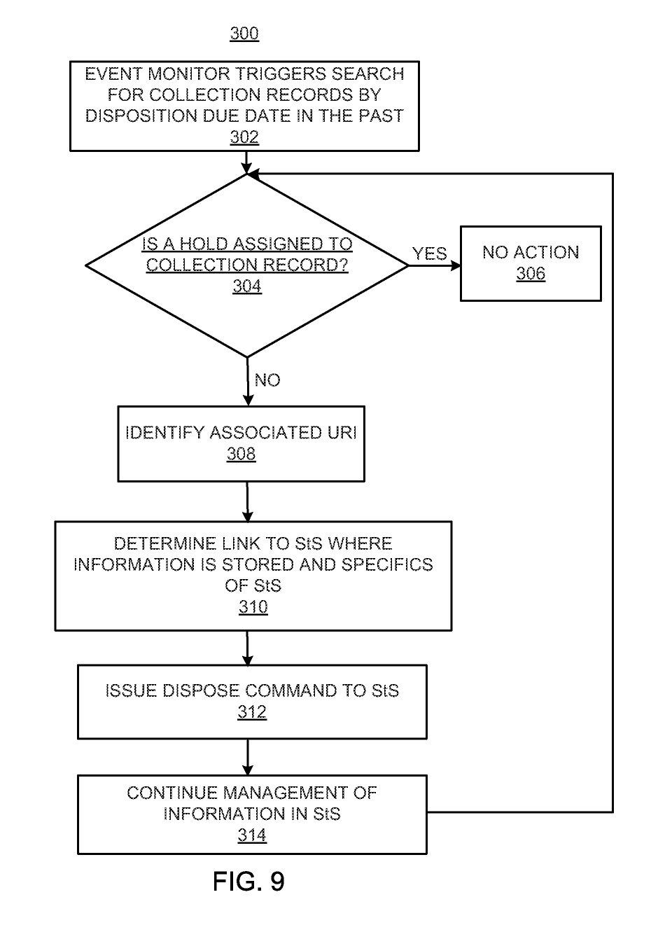

FIG. 8 illustrates a method 200 for information capture according to an embodiment, and FIG. 9 illustrates a method 300 for policy execution according to an embodiment. The methods 200 and 300 are described with respect to central RMS 100 shown in FIGS. 1-7 by way of example and not limitation. The methods 200 and 300 may be performed by other systems.

As shown in FIG. 8, in order to capture information, at block 202 the central RMS 100 may receive a collection record call from the DCA 104 for information identified by the DCA 104 for storage.

At block 204, the central RMS 100 may receive a policy having an associated URI stored for the policy. As described above, receipt of the policy may occur prior to receipt of the collection record call at block 202.

At block 206, responsive to the collection record call form the DCA 104, the central RMS 100 may create the collection record 108 and return the URI 110 associated with the policy to the DCA 104.

As described above for an alternative embodiment, the collection record 108 may be created by the DCA 104 first inquiring with the central RMS 100 to select a capture policy. The DCA 104 may then create a collection under the capture policy and inform the central RMS 100 of the collected information 106. The central RMS 100 may then create a collection record 108, assign the capture policy to the collection record 108, and associate a URI 110 with the collection record 108 and the capture policy.

As also described above for an alternative embodiment, the collection record 108 may also be created by the DCA 104 creating a collection under the capture policy and informing the central RMS 100 of the collected information 106. The central RMS 100 may then create a collection record 108, and associate a URI 110 with the collection record 108. A management policy may be subsequently created and assigned to the URI 110 and the collection record 108.

At block 208, the DCA 104 may instruct external StS 102 to store information associated with the call, and tag the information with the URI 110.

FIG. 9 illustrates a method for policy execution, according to an embodiment.

At block 302 the event monitor module 134 may trigger a search for all collection records 108 with a disposition due date 121 in the past.

At block 304, the policy management module 136 may determine whether any identified collection records are assigned a hold.

At block 306, if the policy management module 136 determines that there is a hold, no further action is taken on the collection record 108.

At block 308, after determining a policy to be enforced, the central RMS 100 may identify the URI 110 associated with the policy. The identification may be performed by evaluating the collection record metadata 120.

At block 310, the central RMS 100 may determine the link 112 to the StS where the information is stored, and further evaluate the table of StS information 114 to determine any specifics of the StS 102. The information in the table of StS information 114 may pertain to the interface that is to be used to execute retention, deletion or hold of RMS managed data stored by each StS.

At block 312, based on the information obtained and calculated from the tables 114, 116 and 118, management module 132 may obtain or confirm appropriate policy information from policy management module 136. Module 132 may thus issue a policy command to the appropriate StS 102 to dispose of the information stored in the StS 102.

At block 314, after implementation of the policy command, the central RMS 100 may return to block 304 for continued management of the information in the STS 102.

### 4. Computer Readable Medium

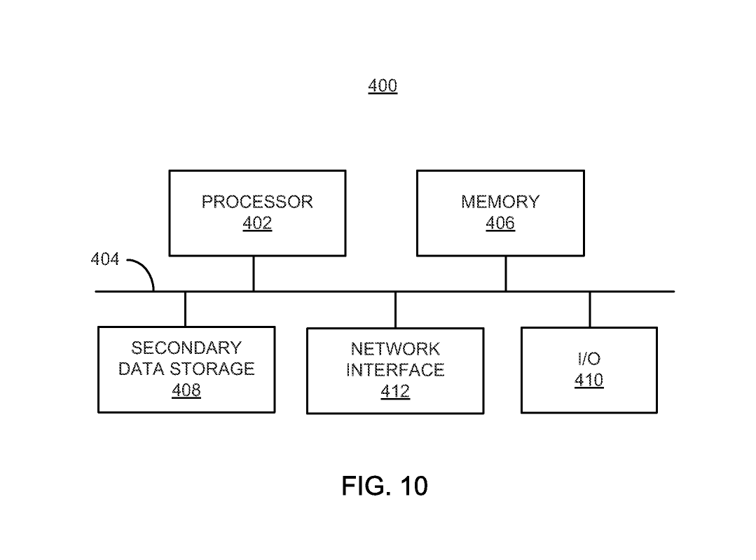

FIG. 10 shows a computer system 400 that may be used with the embodiments described herein. The computer system 400 represents a generic platform that includes components that may be in a server or another computer system. The computer system 400 may be used as a platform for the central RMS 100. The computer system 400 may execute, by a processor or other hardware processing circuit, the methods, functions and other processes described herein. These methods, functions and other processes may be embodied as machine readable instructions stored on computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 400 includes a processor 402 that may implement or execute machine readable instructions performing some or all of the methods, functions and other processes described herein. Commands and data from the processor 402 are communicated over a communication bus 404. The computer system 400 also includes a main memory 406, such as a random access memory (RAM), where the machine readable instructions and data for the processor 402 may reside during runtime, and a secondary data storage 408, which may be non-volatile and stores machine readable instructions and data. The memory and data storage are examples of computer readable mediums.

The computer system 400 may include an I/O device 410, such as a keyboard, a mouse, a display, etc. The computer system 400 may include a network interface 412 for connecting to a network. Other known electronic components may be added or substituted in the computer system 400.

While the embodiments have been described with reference to examples, various modifications to the described embodiments may be made without departing from the scope of the claimed embodiments.

What is claimed is:

1. A records management system comprising:
a policy management module receiving a policy related to retention, disposition or hold of information storable on an external storage system; and
a computerized management module associating a unique record identifier with a collection record including metadata for the information,
wherein the unique record identifier enables management of the information by the computerized management module when the unique record identifier and the information are stored on the external storage system.

2. The records management system of claim 1, wherein the storage system is a federated storage system.

3. The records management system of claim 1, wherein the records management system creates the collection record.

4. The records management system of claim 1, wherein an external data capture agent captures the information.

5. The records management system of claim 1, wherein an external data capture agent creates the collection record.

6. The records management system of claim 1, wherein the collection record includes the metadata for a fixed collection of the information in which all the information is managed as a single set.

7. The records management system of claim 1, wherein the collection record includes the metadata for a dynamic collection of the information in which at least one part of the information is managed separately.

8. The records management system of claim 1, wherein the records management system maintains authority to protect the information from destruction when the unique record identifier and the information are stored on the external storage system.

9. The records management system of claim 1, wherein the records management system maintains authority to destroy the information when the unique record identifier and the information are stored on the external storage system.

10. The records management system of claim 1, wherein the records management system maintains authority to destroy a fixed collection of the information by instructing the external storage system to destroy all of the information stored on the external storage system associated with the unique record identifier.

11. The records management system of claim 1, wherein the records management system maintains authority to destroy a dynamic collection of the information by instructing the external storage system to destroy some of the information stored on the external storage system associated with the unique record identifier.

12. The records management system of claim 1, wherein the records management system maintains authority to place the information stored on the external storage system on hold to prevent any action on the information.

13. The records management system of claim 1, wherein the records management system stores the collection record including the metadata for the information and the unique record identifier, and not the information.

14. A method for record management, the method comprising:
receiving a policy related to retention, disposition or hold of information storable on an external storage system;
associating, by a computer, a unique record identifier with a collection record including metadata for the information; and
managing the information when the unique record identifier and the information are stored on the external storage system.

15. A non-transitory computer readable medium storing machine readable instructions, that when executed by a computer system, perform a method comprising:
receiving a policy related to retention, disposition or hold of information storable on an external storage system;
associating, by a computer, a unique record identifier with a collection record including metadata for the information; and
managing the information when the unique record identifier and the information are stored on the external storage system.
